(19) United States
(12) Patent Application Publication
(10) Pub. No.: US 2005/0264015 A1
(43) Pub. Date: Dec. 1, 2005

(54) Seal

(76) Inventor: Jaume Baucells Granell, Barcelona (ES)

Correspondence Address: GOTTLIEB RACKMAN & REISMAN PC, 270 MADISON AVENUE, 8TH FLOOR, NEW YORK, NY, 100160601, US

(21) Appl. No.: 10/522,112

(22) PCT Filed: Jul. 22, 2003
(86) PCT No.: PCT/ES03/00375

§ 371 Date: Apr. 8, 2005

(30) Foreign Application Priority Data
Jul. 26, 2002 (ES) U200201914

(51) Int. Cl. G09F 3/03

(52) U.S. Cl. 292/325

(57) ABSTRACT

The invention relates to an improved seal comprising: a thin body (1) which is solidly connected to a panel (2) and which is intended to be housed in a tubular passage using support means; and a head (3) which is connected to the panel (2) by means of a weakened portion of material (4) which forms a rupture line and which enables the seal to be used with the head (3) connected to, or detached from the panel (2). According to the invention, the head (3) comprises an outer tubular body (31), a metal plate (32) which is used to support the thin element (1) in the closed position and an inner tubular body (33) which is mounted coaxially, together with the metal plate (32), inside said outer tubular body (31).

### OBJECT OF THE INVENTION

As its title indicates, the present invention relates to an improved seal of the type which comprise a thin body, one end of which is solidly connected to a panel and the opposite end is intended to be housed in a tubular passage with means for supporting the seal in the position for use.

### BACKGROUND OF THE INVENTION

Different seals made of plastic currently exist on the market, which have a thin body which are made up of either a panel or a head and which have one end free, so that the aforementioned thin body can be inserted in a tubular passage in the panel or head so that when the seal is in the closed position, it forms a hoop or loop.

The thin body of these seals generally has inclining serrated edges against which the support means on the inside of the tubular passage press, these support means allowing the thin body to move forwards, but not backwards, through the inside, to ensure the closed position of the seal.

As already mentioned, when in the position for use, these seals always form a closed loop or hoop, and are useless once broken.

Depending on the type of element or elements to be sealed, in some cases it is not viable to use the seals mentioned earlier, precisely because of the loop or hoop configuration they adopt in the closed position.

The problem which arises is therefore how to obtain a seal which can be used in the same way as conventional seals but which can also seal or close a variety of elements, the thin body and the whole seal array adopting an open configuration, i.e. without forming a closed hoop or loop.

### DESCRIPTION OF THE INVENTION

The improved seal being the object of the invention, is of the type which comprise a thin body, one end of which is solidly connected to a panel, and the free end of the thin body is intended to be housed in a tubular passage with means for supporting the seal in a position for use, and which has certain constructive features enabling utilization of the seal both in a closed configuration as well as an open configuration in the closed position.

According to the invention, the seal comprises a head which adjoins the panel and is attached to said panel by means of a weakened portion of material which forms a rupture line and enables the seal to be used with the head connected to the panel, the seal forming a closed loop in the position for use, or enables the seal to be used when detached from the head of the panel, the thin element adopting an open configuration and the panel and the head both forming stoppers in the ends of said thin element.

Given that the head is solidly connected to the panel, said head therefore comprises an outer tubular body moulded together with the panel; a metal plate which is used to support the thin element in the closed position and an inner tubular body which is mounted coaxially, together with the metal plate inside the outer tubular body.

This configuration of the head significantly simplifies the tasks involved in manufacturing the seal, especially considering that the metal plate has to be mounted inside the head.

In this way, the outer tubular body of the head, the panel and the thin element are moulded together to form a single part.

To help mount the inner tubular body and the metal plate which make up the means for supporting the thin body in the outer tubular body, said outer tubular body has a small opening in one of its ends, which is of an appropriate size to allow the thin element to enter inside it, and in the opposite end is a larger opening in which the metal plate and the inner tubular body are inserted, the aforementioned opening being fixed, preferably heat-soldered, onto the inner tubular body.

In this way, the head can be mounted quickly and easily.

According to the invention, the metal plate providing the means for supporting the thin body in the assembly position has, in the part through which the thin body passes, a truncated cone configuration with flaps around the outer edge, which converge in the direction in which the thin body enters inside the head.

The aforementioned thin body has a smooth outer surface, i.e. it is not serrated, and its free end has a section with a diameter, which is slightly smaller than the rest of the section, making it easier to insert in the head.

Both the thin body and the hole outlined by the front ends of the flaps on the metal plate are conveniently sized so that said flaps can be separated elastically when the thin element is inserted, exerting pressure on the element which, together with the inclining flaps, prevents the thin body from moving backwards or from being released once the seal is in the closed position.

### DESCRIPTION OF THE DRAWINGS

To complement the description given and to help provide a better understanding of the characteristics of the invention, a set of drawings are provided with the present specification which represent the following, in an illustrative and non-limitative way:

FIG. 1 shows an elevational view of the improved seal being the object of the invention in which the head can be seen connected to the panel.

FIG. 2 shows a magnified view in detail of the head after being separated from the panel and cut in a vertical cross-section in which the components can be seen.

FIG. 3 shows a ground view of the metal support plate.

FIG. 4 shows an elevational view of the metal plate cut in a vertical cross-section.

FIGS. 5 and 6 both show perspective views of the seal in the position for use, in a closed-loop configuration and an open configuration respectively, in the latter, the panel and the head forming two end stoppers.

### PREFERRED EMBODIMENT OF THE INVENTION

As can be seen in the above figures, the improved seal being the object of the invention has a thin body (1) with one of its ends solidly connected to a panel (2) to which a head (3) is adjoined; said head (3) having a tubular passage on the inside for insertion of the free end of the body (1) to the position for use or closed position of the seal.

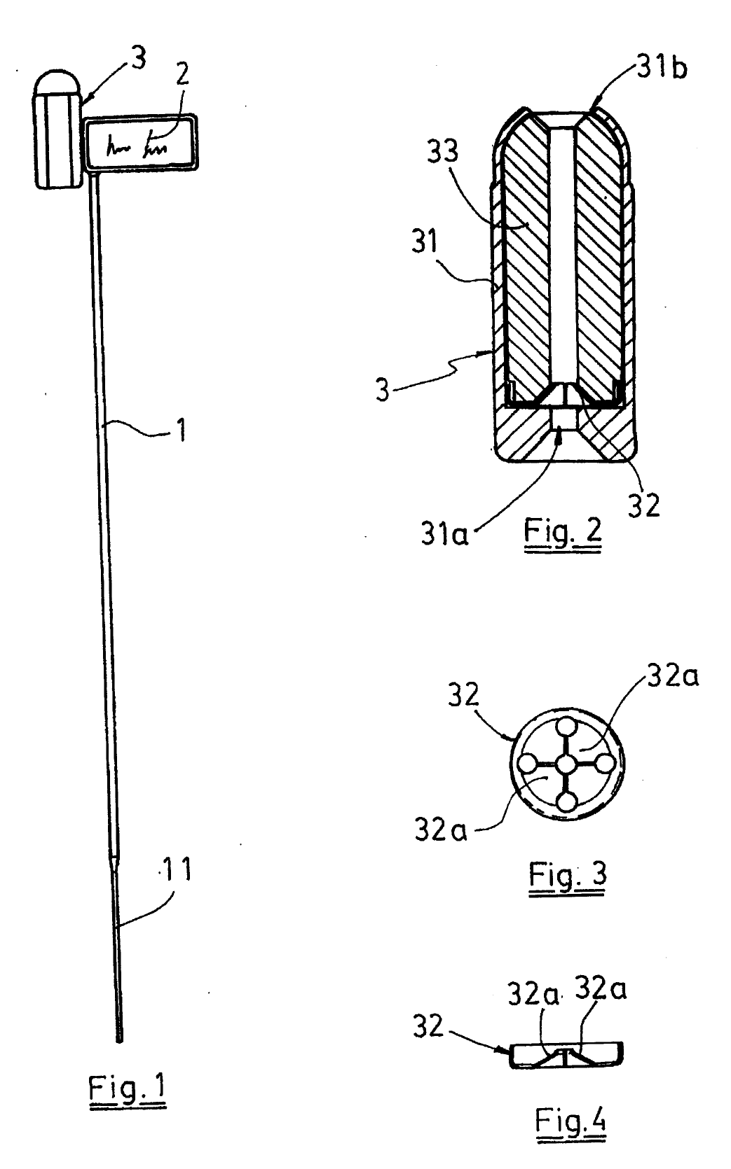

The aforementioned head (3) is fixed to the panel (2) by means of a weakened portion of material (4), which forms a rupture line. The head (3), as can be seen in FIG. 2, comprises an outer tubular body (31) which is formed together with the panel (2), a metal plate (32) to form the support means of the thin body (1) in the seal's position for use, and an inner tubular body (33).

The outer tubular body (31) has a small opening (31a) in one of its ends and in the opposite end is a larger opening (31b) through which the metal plate (32) and the inner tubular body (33) are inserted, said larger opening (31b) being fixed, preferably heat-soldered, onto the inner tubular body (33).

The metal plate (32) has a truncated cone configuration formed by flaps (32a) on the edge, which converge in the direction in which the thin body (1) moves towards the closed position.

The aforementioned thin body (1) has a smooth outer surface and its free end has a section (11) with a smaller diameter, intended to make the initial insertion through the head (3) easier.

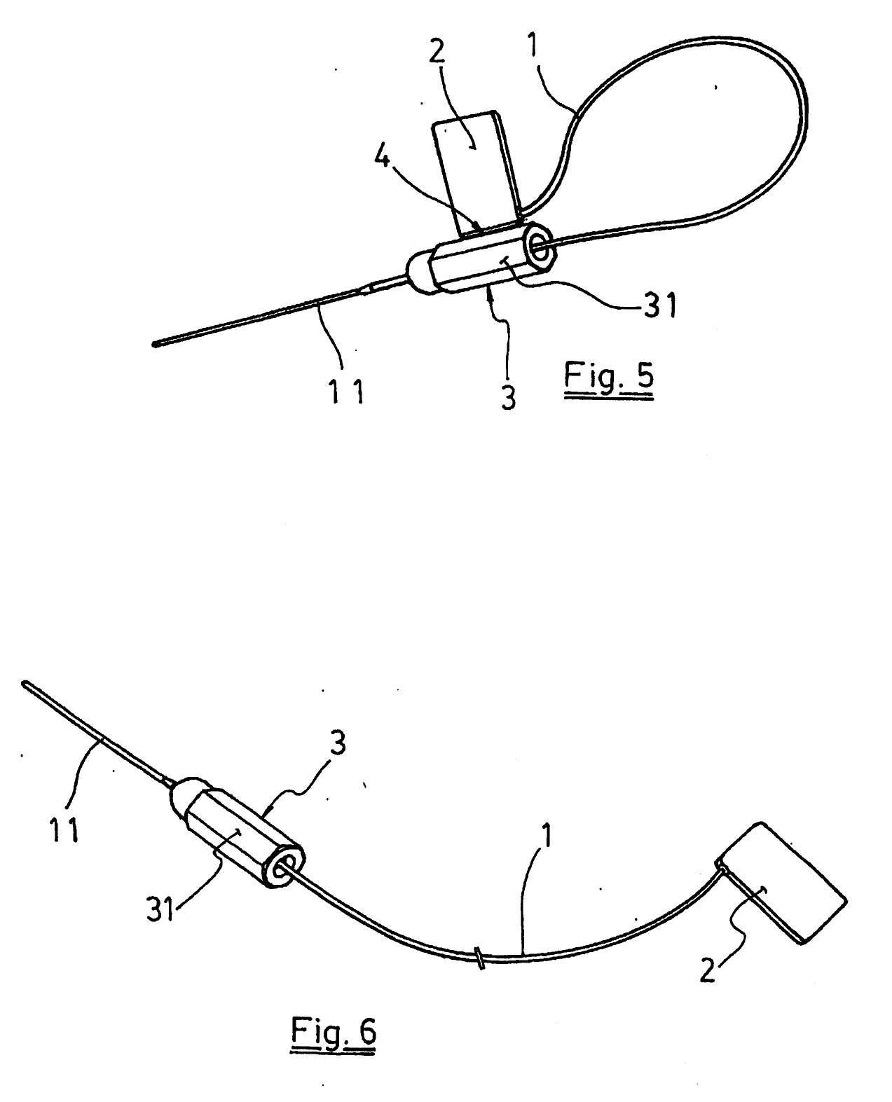

The join between the head (3) and the panel (2) by means of the weakened portion of material (4), as seen in FIG. 5, enables the seal to be used without detaching the head (3) from the panel (2), in this case the thin body (1) forms a closed loop when it is in the closed position; or, enabling the seal to be used after the panel (2) has been detached from the head (3), in which case the thin body (1) adopts an open configuration, the panel (2) and the head (3) forming end stoppers of the seal, as seen in FIG. 6.

An adequate description of the nature of the invention and an example of a preferred embodiment having been given, it should also be mentioned that, if necessary, the materials, form, size and layout of the elements described may be modified, but only when this does not imply any change to the essential characteristics of the invention claimed hereinafter.

1. Improved seal; of the type which comprise a thin body (1), one end of which is solidly connected to a panel (2), and the opposite end is intended to be housed in a tubular passage with means for supporting the seal in a position for use; characterized in that it comprises a head (3) which adjoins the panel (2) and is attached to said panel (2) by means of a weakened portion of material (4) which forms a rupture line and enables the seal to be used with the head (3) connected to the panel (2), the seal forming a closed loop in the position for use, or enables the seal to be used when detached from the head (3) of the panel (2), the thin element (1) adopting an open configuration and the panel (2) and the head (3) both forming stoppers in the ends of said thin element (1) in the seal's position for use.

2. Seal, according to the claim 1, characterized in that the head (3) comprises an outer tubular body (31), moulded together with the panel (2), a metal plate (32) used to support the thin element (1) in the seal's closed position, and an inner tubular body (33) mounted coaxially, together with the metal plate (32), inside said outer tubular body (31).

3. Seal, according to claim 2, characterized in that the outer tubular body (31) has a small opening (31a) in one of its ends, which is of an appropriate size to allow the thin element (1) to be inserted through it, and in the opposite end is a larger opening (31b) in which the metal plate (32) and the inner tubular body (33) are inserted, the aforementioned larger opening (31b) being fixed, preferably heat-soldered, onto the inner tubular body (33).

4. Seal, according to claim 1, characterized in that, in the part through which the thin body (1) passes, the metal plate (32) has a truncated cone configuration with flaps (32a) around the outer edge which converge in the direction in which the thin body (1) enters inside the head (3).

5. Seal, according to claim 1, characterized in that the thin body (1) has a smooth surface and its free end has a section (11) with a diameter which is slightly smaller than the rest of the section, making it easier to insert in the head (3).
